(19) United States
(12) Patent Application Publication
(10) Pub. No.: US 2020/0290647 A1
(43) Pub. Date: Sep. 17, 2020

(54) COORDINATED AUTONOMOUS DRIVING

(71) Applicant: Intel Corporation, Santa Clara, CA (US)

(72) Inventor: Glen J. ANDERSON, Beaverton, OR (US)

(21) Appl. No.: 16/649,021

(22) PCT Filed: Dec. 20, 2017
(86) PCT No.: PCT/US2017/067716

§ 371 Date: Mar. 19, 2020

(51) Int. Cl. B60W 60/00; G08G 1/09; G08G 1/00; G01C 21/34; G01C 21/36

(52) U.S. Cl. CPC B60W 60/00133; G08G 1/091; G01C 21/3691; G01C 21/3453; G01C 21/3415; G08G 1/22

(57) ABSTRACT

Autonomous vehicles leave passengers with time to perform activities while awaiting travel to conclude. While one might engage in reading, playing games, or conversing with others, it is expected another common activity will be to sleep. Disclosed are various examples of how to coordinate a traffic control system with home and vehicle environments to enable allowing a person to be able to sleep while traveling, where travel is in accord with personal preferences, and constraints, such as schedule or systemic constraints (e.g., traffic). It will be appreciated passengers may be transferred to their vehicle while still asleep, or monitored to determine a time to awaken the passenger for transfer to the vehicle such that the passenger is more likely to be able to return to sleep for the travel.

### TECHNICAL FIELD

The present disclosure relates to autonomous driving, and more particularly, to coordinating vehicle routing with one or more characteristics associated with one or more passenger.

### BACKGROUND AND DESCRIPTION OF RELATED ART

Over the past several years that has been a lot of research into automating vehicle operation, such as providing autonomous vehicles designed to automatically drive passengers around with little to no passenger assistance. It will be appreciated this is a developing technology area and many different organizations are seeking to standardize the operation of such vehicles. For example, the Society of Automotive Engineers (SAE), a globally reaching organization has defined levels of driving automation in SAE International standard J3016. See, e.g., Internet Uniform Resource Locator (URL) www.sae.org/misc/pdfs/automated_driving.pdf. The SAE system is a good overview of some types of autonomous vehicles, where of the 5 automation levels the last three (levels 3-5) correspond to what one might think of as a vehicle doing the driving for the passengers. In response to developing technologies, various legislative entities seek to establish regulations concerning autonomous vehicle operation. See, for example, the National Conference of State Legislatures (NCSL) Internet web site that seeks to track legislative responses to autonomous vehicles. The NCSL states “Autonomous vehicles seem poised to transform and disrupt many of the basic, longstanding fundamentals of the American transportation system. As the technology for autonomous vehicles continues to develop, state governments are beginning to debate and address the potential benefits and impacts of these vehicles.” See Internet URL www.ncsl.org/research/transportation/ autonomous-vehicles-legislative-database.aspx.

It will be appreciated while being autonomous, autonomous vehicles may be expected to operate in conjunction with smart environments, such as a “smart city” traffic control to assist autonomous vehicles. An exemplary test environment is the University of Michigan's 32-acre Mobility Transformation Center (MCity). See Internet URL mcity.umich.edu/ our-work/mcity-test-facility. Technologies such as these may provide a safe environment in which autonomous vehicles may operate. But, while much of the technical developments and legislative effort concerns creation of safe cars and regulatory environments to promote continued development, an interesting issue remains: what to do while in an automated vehicle? And how might that affect the operation of the autonomous vehicle?

### BRIEF DESCRIPTION OF THE DRAWINGS

Embodiments will be readily understood by the following detailed description in conjunction with the accompanying drawings. Illustrate drawing elements may correspond to one or more embodiments described herein. To facilitate description, like reference numerals designate like structural elements. Embodiments are illustrated by way of example, and not by way of limitation, in the figures of the accompanying drawings.

FIG. 1 illustrates an exemplary high-level data flow 100.

FIG. 2 illustrates an exemplary environment 200.

FIG. 3 illustrates an exemplary environment 300.

FIG. 4 illustrates an exemplary environment 400.

FIG. 5 illustrates an exemplary computer device 500 that may employ the apparatuses and/or methods described herein.

FIG. 6 illustrates an exemplary computer-readable storage medium 600.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations do not have to be performed in the order of presentation. Operations described may be performed in a different order than the described embodiment. Various additional operations may be performed and/or described operations may be omitted in additional embodiments. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are considered synonymous.

As used herein, the term “circuitry” or “circuit” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, processor, microprocessor, programmable gate array (PGA), field programmable gate array (FPGA), digital signal processor (DSP) and/or other suitable components that provide the described functionality. Note while this disclosure may refer to a processor in the singular, this is for expository convenience only, and one skilled in the art will appreciate multiple processors, processors with multiple cores, virtual processors, etc., may be employed to perform the disclosed embodiments.

As used herein, the term semi-autonomous driving is synonymous with computer-assisted driving. The term does not mean exactly 50% of the driving functions are automated. The percentage of automated driving functions may vary between 0% and 100%. In addition, it will be appreciated the hardware, circuitry and/or software implementing the semi-autonomous driving may temporarily provide no automation, or 100% automation, such as in response to an emergency situation.

### Overview

As noted above, autonomous vehicles leave passengers with time to perform activities while awaiting travel to conclude. While one might engage in reading, playing games, or conversing with others, it is expected another common activity will be to sleep. Once a vehicle is able to be in charge of the traveling, the passengers may be able to take advantage of this to catch up on sleep. It is well know that many people do not get enough sleep, and automated vehicles provide a great opportunity for passengers to sleep during commutes or other traveling. It will be appreciated there are a variety of wearable devices that may be used to monitor a passenger's status, such as heart rate, blood pressure, breathing, as well as sleeping status, e.g., a simple sleeping yes/no, as well as a predicted determination whether someone is lightly sleeping, deeply asleep, in REM (rapid eye movement) sleep, etc. See for example the “fitbit” products discussed at Internet URL www.fitbit.com that provide sleep tracking functionality. This is just one exemplary wearable that may be used.

It will be appreciated such wearable technology may be used in conjunction with ballistocardiography devices, which may, for example, be integrated into a vehicle, such as within a seat, to assist with sleep (or other passenger status) tracking and evaluation. In addition, these technologies may also be used within a home, including integration with a bed. Assuming use of a wearable or other technology for monitoring a passenger either at home or within a vehicle, it is assumed that the tracking includes identifying a passenger's sleep cycle. One benefit of identifying the sleep cycle is a sleeper is often able to awake from a shallow sleep state and then go back to sleep and engage in a deeper sleep. This is in contrast to when a sleeper awakes from a deeper sleep, where it is often harder to get back to sleep. Regardless of the sleep cycle, it is possible for a passenger to awaken, perform an activity such as dressing for work, get in a vehicle and then go back to sleep. It is known that if one keeps lighting dim, electronic devices off (avoid the blue lights of devices), and take other precautions against waking one's brain, this helps one's ability to get back to sleep.

Since everyone may have a different sleep cycle, based in part on their monitored physiology, as well as in part on when they went to sleep, and other factors, there may be different times of the day (assuming a common clock) that represent a better time to temporarily awaken a passenger such that it is more conducive to getting back to sleep. It will be appreciated autonomous vehicles could cooperate with sleep monitoring systems, which include some form of artificial intelligence (AI), such as an expert system, prediction system, reasoning system, neural network (e.g., deep learning system, deep feedforward system, or deep recurrent system), or the like. The term “AI” will be used herein to generally refer to all of these intelligence/reasoning systems. It will be appreciated the Al may be a standalone computational system communicatively coupled to a passenger's home or the autonomous vehicle, or it may be incorporated within any one of the autonomous vehicle and/or home. The autonomous vehicle may then attempt to maximize desired goals, such as maximizing passenger sleep, while also seeking to satisfy other goals that might be important to the passenger and/or society. For example, the autonomous vehicle might also attempt to operate to increase fuel efficiency, make traffic control more efficient for the overall traffic system, maximize the passenger's interest and/or pleasure in the travel, or the like.

While maximizing sleep is on important potential goal of the disclosed environments, travel can also be determined with respect to other passenger preferences, e.g., some people like being woken early, others later in the day. One's calendar or schedule of events may also affect travel planning, including making a stop to engage in a desired activity, such as a conference call, and then resuming travel. In addition travel can be arranged to accommodate interest in reading at a certain location, watching a broadcast, catching up on a television series, and the like. Driving need not be continuous from start to destination, as noted above there are a variety of activities that may be performed while traveling, including stopping to enjoy a desired event, or simply to see a pretty location/view. Or, as noted above, the vehicle may stop and allow the passenger to continue to sleep undisturbed while waiting for traffic or other potential route interruptions or inefficiencies to alleviate.

These considerations can all be factored in to route planning to maximize passenger preferences while also assisting with minimizing traffic congestion. For example, there is a systemic benefit to routing a passenger to side roads if that is consistent with other preferences, or to stop travel at a desired location to allow for engaging in some activity that is productive and positive while simultaneously staying out of morning traffic congestion. If many autonomous vehicles engage in such intelligent route planning, the number of vehicles on the road may be reduced and their interactions better optimized, thus reducing emissions from stopped cars, increasing fuel efficiency from lack of stop-and-go traffic, reducing the number of accidents, improving traffic intersection engagements, and the like. Cumulatively, allowing autonomous vehicles to efficiently route passengers based on their sleep needs and other activity desired along a route, the cumulative effect will be to provide environmental and economic benefits while also maximizing passenger happiness with the travel experience.

The term “vehicle” is intended to broadly cover any manner of conveying a passenger or other item of interest from one location to another.

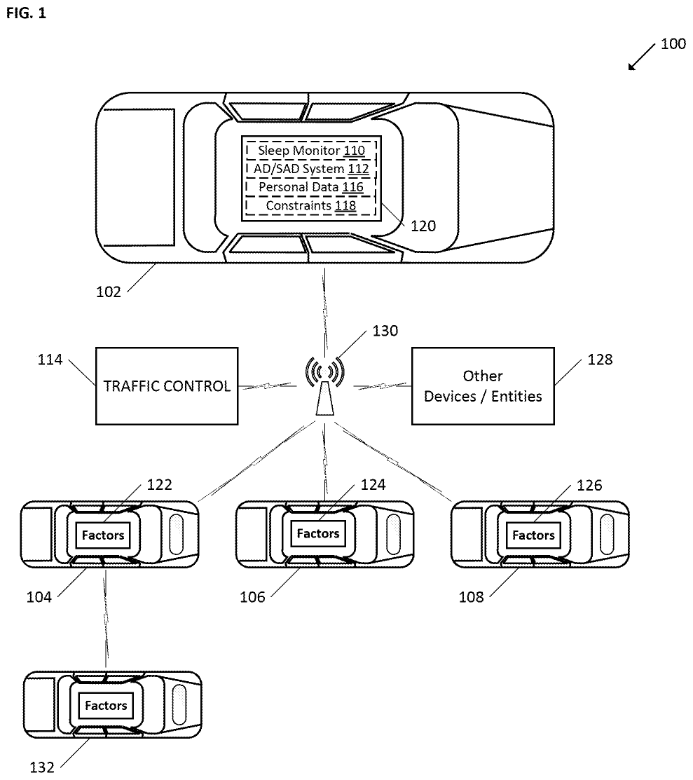

FIG. 1 illustrates an exemplary high-level data flow 100. In the illustrated embodiment, assume an automobile 102 contains an in-car sleep monitoring system 110 that operates in conjunction with an autonomous and/or semi-autonomous (if a driver elects to assist) driving system (AD/SAD) 112, and a traffic control system 114 to coordinate traffic flow and sleep cycles of commuters and other travelers in vehicles 104-108. It will be appreciated while only one traffic control system is illustrated it may represent a combination of multiple different control systems, devices, technology, traffic signals, roadway/railway/passageway controls, etc. For example, interaction with the vehicles may include physical signage and/or signaling, in addition to data communication and directives exchanged with the vehicles. Traffic control may provide directives to the vehicles that then act on the directives autonomously, and/or traffic control may in some circumstances directly control the vehicles. This latter case may be due to an emergency, a request from an authority (e.g., a police request to stop a vehicle), or complexity, such as to more efficiently interweave operation of many vehicles.

In the illustrated embodiment, typical use of the illustrated vehicles will be by people. However, since vehicles may be fully autonomous, they may also be used to transport animals, packages, data (e.g., a physical transported item or data embedded or otherwise stored within a vehicle), etc. In the illustrated embodiment, assuming privacy regulations or other controls might limit disclosing personal information, it is assumed passengers opt in to the system and agree to share personal data 116 such as medical data, sleep monitoring information, calendar information, route preferences, allergies/intolerances (to allow avoiding troublesome areas such as high pollen or grass areas), etc. It will be appreciated these personal data examples are presented as examples only and that these and/or other personal data may be shared. The personal data 116 may be generally thought of as any information or thing a passenger or other entity would want to give permission before providing/sharing. It will be appreciated personal data may also include any data subject to privacy regulation, such as laws, statutes, and or regulations such as those provided by various regions of the United States (e.g., United States Privacy Act, Safe Harbor Act, Health Insurance Portability and Accountability Act (HIPA)) or regulations in other countries (e.g., Canada (Personal Information Protection and Electronic Documents Act (PIPEDA)), European Union (General Data Protection Regulation (GDPR)), United Kingdom (Data Protection Act), etc.).

In addition to personal data, a passenger and/or vehicle may have associated constraints 118 that may affect operation of the vehicle. For example, in addition to scheduling data that might be in a passenger's personal data, the passenger might have set constraints that the driving system needs to meet. For example, a passenger might set a constraint that a minimum number of hours of sleep is a priority, and therefore the routing of a vehicle should attempt to realize that goal. Implementing this may take a variety of forms including driving at slower speeds, driving on quieter or slower side roads, avoiding roadways under construction, avoiding roads identified as bumpy or having a noisy surface (certain road designs generate vibrations and noises as vehicles traverse the surface). Constraints may be treated as rules where the AD/SAD system tries to resolve a set of rules with a best solution available. Other constraints may come from route preferences which can be combined with expected events so that a drive may be more pleasurable.

For example, assuming a passenger had a constraint of wanting 7 hours sleep and a preference for scenery, the AD/SAD might navigate the vehicle off major roadways and time a drive through a countryside so that an awakening after the 7 hours has the passenger awaking in a scenic area. The passenger may then elect to be driven directly to a desired destination, e.g., work, once the passenger has enjoyed a pleasant awakening. As illustrated, the exemplary sleep monitor 110, AD/SAD system 112, personal data 116 and constraints 118 may collectively be referred to as exemplary factors 120 that are considered by vehicle 102 and traffic control 114 to facilitate an efficient operation and routing of the vehicle in accord with the interests of the passenger(s). The other exemplary vehicles 104-108 may also have factors 122-126 considered by the vehicles and traffic control.

In the illustrated embodiment, the traffic control system 114 may direct vehicles 102-108 based on the various factors 120-126 associated with the vehicles and/or passenger(s) in the vehicles. For example, each of the vehicles may have an associated planned ETA based on scheduled calendar meetings for the various passengers in the vehicles. If in one vehicle 102 a passenger's sleep monitor 110 indicates the driver has just entered a deep sleep, and the vehicle determines it is 10 minutes away from work and the passenger does not need to arrive at work for another for another 40 minutes, the vehicle may elect to leave traffic and allow the passenger to sleep for another half hour before resuming travel to work. It will be appreciated cities may allow vehicles to pull over and wait. For example, there may be designated pull-off locations where vehicles may securely stop and allow passengers to rest. Or, vehicles may simply pull onto the shoulder of a road, since in an automation environment, this may be less of a road hazard as it might be today since traffic control 114 and other vehicles 104-108 would be aware of the stopped vehicle 102 and avoid it. It will be appreciated a variety of technologies may be used to share information between vehicles 102-108, traffic control 114, and other devices and/or entities which are generally illustrated for exemplary purposes as item 128.

In the illustrated embodiment the various communication technologies are generally illustrated with respect to an access point 130. It will be appreciated the technology may be any wireless (including inductive signaling) and/or wired or other form of data path allowing transferring data. Data connections, it may be point-to-point, a mesh configuration, piggy-back (e.g., one vehicle bridges communication for another vehicle 132 that may be out of range of the access point), access to a common network such as the Internet or other network, cellular based, using microwave technology, or the like. While a variety of possible connectivity options are aggregated into the illustrated access point 130, it will be appreciated some of these other technologies may have separate data networks. For example, there may be a wireless cellular network communicatively coupling some vehicles, and there may also be other devices that may be used to assist with communication, such as roadside pylons that may have a separate network (wired or wireless) that can communicate with other vehicles and the cellular network.

Continuing the above example, assuming the passenger is due to awake, the vehicle 102 can awaken the passenger. It will be appreciated a variety of techniques may be employed to awaken a passenger peacefully, e.g., without a jarring alarm, and that the vehicle may (using the sleep monitor 110) pick a more-likely to be positive time to attempt the awakening. That is, sleep cycles have moments of lighter and deeper sleep and awakening from a deep sleep portion of a cycle can leave one groggy and/or disoriented (akin to drunkenness for some). The instead may seek to balance travel/arrival constraints, such as a needed arrive-by time, with picking a light-sleep portion of a sleeping cycle as the moment to start waking the passenger. Once awake, the vehicle 102 may then re-integrate with traffic and continue the passenger on toward a desired destination. As noted above, a passenger may have preferences, such as for scenery, and the vehicle may have pulled off to wait at a view point, or other location of interest or likely to be of interest to the passenger.

Once the vehicle is back on its route, the traffic control system 114 may be notified so that it and other vehicles adjust for the presence of the vehicle. It will be appreciated other considerations, such as fuel economy, may affect traffic control decisions. Thus for example if all illustrated vehicles are at least temporarily traveling the same route, traffic control could direct the cars to form a caravan or train of vehicles, since collectively, such configurations may achieve improved fuel economy. It will be appreciated cars may literally couple together depending on the technology, or they may simply drive closely together operating collectively under the control of traffic control or other guidance system. It will be appreciated autonomous vehicles are intelligent and they may form a local control network independent of traffic control and effectively operate as a single vehicle for traffic control to manage. It will be appreciated not all roads may have a traffic control and a vehicle may operate independently on any road. Therefore, it will be appreciated the caravan of vehicles would also be able to travel on roadways not under control of traffic control. It will be further appreciated that a lead car in a caravan may have higher fuel costs since it does not benefit from being in a draft position behind other vehicles. Various options are available to provide for an equitable caravan, such as allowing for micropayments to be exchanged between vehicles/owning entities to adjust for additional costs or other charges to the leader, as well as for dynamically rearranging the caravan so that other cars share the lead role and thus share the leader burden.

It will be appreciated traffic control may perform many different tasks besides coordinating traffic flow. Traffic control could include many tasks including, as an example: moving vehicles on and off of various roads to improve traffic flow, such as to minimize congestion by prioritizing traffic to vehicles needing to arrive sooner than others; monitoring parking and adjusting arrival for when parking spots are open or likely to open soon (e.g., the end of a sporting or other event, end of a workday, or other event likely to free up parking may be factored in to arrival determination); taking a slow or scenic route when a passenger does not have an urgent arrival need and may enjoy a more leisurely travel; vehicle-schedule permitting, temporarily stopping travel to allow congestion or other obstruction, construction, weather, visibility, or other condition affecting travel to clear up.

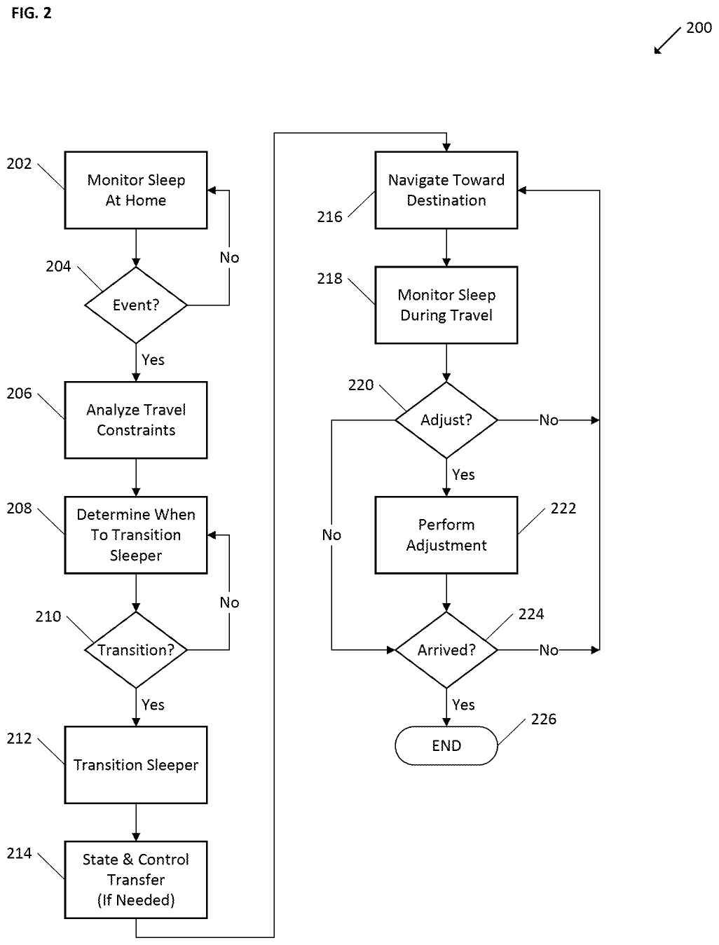

FIG. 2 illustrates an exemplary environment 200 in accord with FIG. 1. In this illustrated embodiment, a vehicle's 102 sleep monitoring 110 may interact in multiple ways with the vehicle's navigation and traffic control 114.

As discussed above, the sleep monitoring may monitor sleep cycles at various times to facilitate conveying a passenger to a desired destination. For example the system may monitor 202 someone sleeping at home. The home system may check, for example, a calendar for the sleeping person and determine if 204 there is an event, such as travel to work. If so the system may then analyze 206 travel constraints such as the event or other considerations, and compare the travel constraints with the monitored sleeping to determine 208 when it is a good time to transition the sleeper from sleeping at home to sleeping while beginning travel to a destination that allows the sleeper to complete a desired sleep cycle while traveling, such as to work. It will be appreciated analyzing 206 travel constraints may include considering other tasks, such as interest in watching a live broadcast, having time to read a book, or accommodating systemic interests such as coordinating multiple vehicles to distribute the amount of traffic on a road at any particular time. The monitoring system may consider all of these personal and systemic interests as constraints affecting if and when a sleeping person is transitioned to a vehicle.

In the illustrated embodiment, if 210 it is time to transition the sleeper, the sleeper is transitioned 212 to the vehicle. It will be appreciated a good time to transition a sleeper may be when the sleeper is in a light sleep cycle as determined by a sleep monitor associated with the sleeper. Awakening a sleeper during a light sleep cycle facilitates the sleeper being able to get back to sleep if the transitioning to a vehicle wakes the sleeper. Note that the term transition has been used since while one arrangement may be to awaken a sleeper and then facilitate their going back to sleep once in their vehicle It will be appreciated depending on the technology involved one might sleep in a sleeping pod or other device that may be removed from a first location, such as a home, and transitioned to a vehicle configured to receive the sleeping pod without awakening the sleeper. For example, larger vehicles such as recreation vehicles (RVs) are large enough to receive a sleeping pod. In an environment of homes and vehicles having autonomous capabilities, one may elect a transition from sleeping in one location and transitioning to a new one, by moving the sleeping pod, so that the sleeper need not even temporarily awaken. But as noted above if 210 it was a good time to transition, if the sleeper is disturbed during transition, sleep may be reacquired.

Once the transition 212 occurs, it will be appreciated there may be a transfer 214 (if needed) of information state and/or control from a home monitoring environment (e.g., home AI) to a vehicle monitoring environment (e.g., vehicle AI). That is, it will be appreciated in one embodiment there may be different AIs for home, vehicle, work, etc. and when a sleeper transitions from one location to another a different controlling AI may take charge after a transfer of state for the sleeper. In another embodiment, the controlling AI may be a single executing program distributed across the multiple environments, such as home and vehicle. Or it may be some combination of these, such as devices associated with a sleeper using one AI what works in conjunction with other AIs in other environments such as for work, traffic control, etc.

After the transition 212 to the vehicle and state transfer 214 (if needed), the vehicle may monitor passenger sleep cycles while traveling so as to minimize waking. For example, as discussed above, route selection (e.g., avoid noisy, bumpy, twisty, congested, etc. routes) and driving modes (e.g., reduced speeds, electing different shift points to minimize engine revving, reduced speeds in turns, etc.) may be implemented in a fashion to minimize the likelihood of waking a passenger. It will be appreciated that other autonomous vehicles may be made aware of the vehicle's driving plan so that they may adjust accordingly. It will be appreciated a traffic control system may adjust traffic controls, time lights, etc. to maximize comfort to passengers in various vehicles. There are many heuristics that may be applied to get a maximal benefit to the largest number of passengers.

It is understood that although the discussion has focused on a single passenger there may be multiple passengers that are asleep and they may originate from the same starting location, or they may be picked up akin to a carpool operation, or public transportation. When there are multiple passengers the controlling systems, e.g., in a house, vehicle, traffic control, etc., are expected to communicate and coordinate activity to best meet the constraints associated with a collection of passengers. In such fashion the systems may, for example, optimize sleep between multiple passengers in the same vehicle, and control wakeup times across carpooled passengers as best meets the passenger needs and interests. As discussed with respect to FIG. 1 all passengers may have associated personal data 116 and constraints 118 that are factored into vehicle and systemic (e.g., traffic control level) decision-making.

Once the operation state of the vehicle is set, then the vehicle may begin to navigate 216 the passenger toward a destination. As discussed previously the current destination may be a workplace, or some other location, as well as a series of locations that satisfy the constraint(s) of the passenger(s). Assuming the passenger intends to sleep for an entire cycle, the vehicle may monitor 218 the passenger's sleep and determine if 220 a travel adjustment needed. If so, an adjustment 222 may be made. Note that an adjustment may be the vehicle performing a navigation adjustment to minimize its passenger's disturbances. However, the vehicle may be cooperatively operating with other vehicles, either directly or by way of or with assistance by traffic control, to minimize disturbances to vehicles' passengers and/or meet travel constraints. Therefore the adjustment 222 may include or may be action taken by other vehicles and/or the traffic control system to assist with the vehicle's travel.

If 220 adjustment was not needed, processing may loop back to continuing navigation. If an adjustment was performed 222 then a test may be performed to determine if 224 the vehicle has arrived at its destination. If so, then processing in this example may end 226, and if not, then processing may loop back continuing navigation. It will be understood that this is a highly-simplified data flow and that many other tasks, not illustrated, may be performed rather than the illustrated looping back to continue navigation 216.

It will be appreciated that while much focus has been put on maximizing sleep, as discussed above, other activities may be the subject of the travel constraints, such as navigating and possibly stopping to enable having time to work on a task, watch TV or perhaps read. And while this may be performed while in motion, some passengers cannot do these things while a vehicle is in motion and this could be a constraint that is analyzed 206 and used to affect when a sleeper is transitioned 212 so that there is time perform other tasks before arriving. By having vehicles perform these activities in real time in conjunction with a traffic control system that can adjust lights and other traffic controls, the traffic environment can be optimized to reduce congestion, risk of accidents, pollution, wear and tear on vehicles, etc.

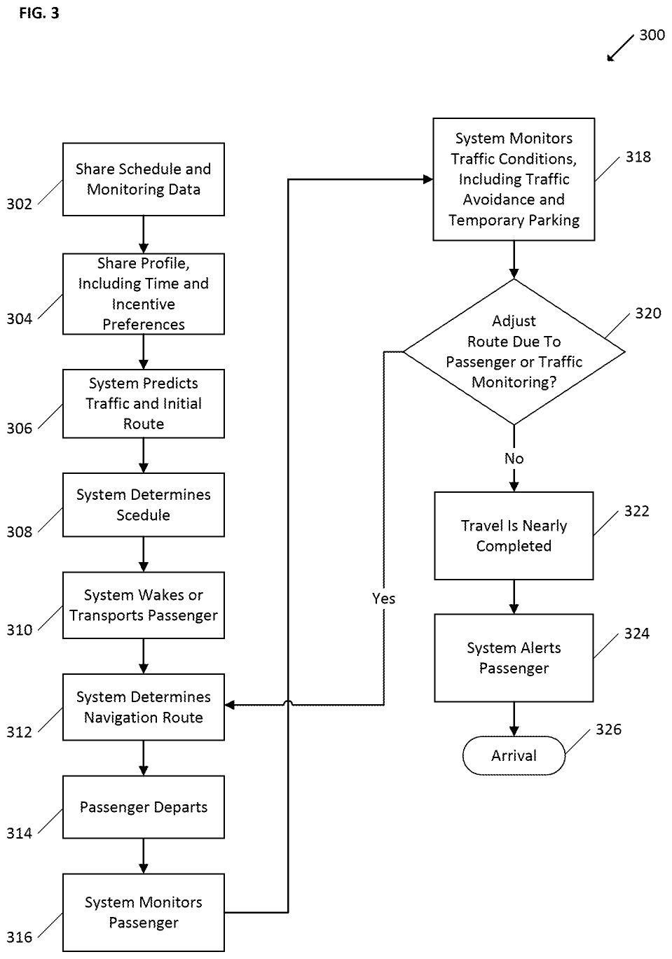

FIG. 3 illustrates an exemplary environment 300 in accord with FIG. 2. As illustrated a person who will be a passenger opts-in (in accord with applicable data privacy regulations) to the system, and shares 302 her personal data, e.g., schedule information, sleep cycle monitoring, and other data of interest to the system that the passenger is willing to share. In her profile she selects a desired 6-7 am departure time, requests low-cost electrical charging as her incentive for providing a flexible departure, and indicates delay and parking requirements, e.g., to identify where she will or will not allow her vehicle to detour while traveling, where to temporarily stop during travel, or park when she arrives. It will be appreciated that this is exemplary data only and that this and other information that may relate to traveling may be associated with the traveler and shared with the vehicle and/or environment, e.g., traffic control and/or other entities that may have an interest or control in some or all of the traveling.

After sharing 320 the personal data the she may then share 304 her profile. The system, e.g., a house AI, vehicle AI, traffic control, or some combination of these or other associated controllers. The system may use this data, at least in part, to predict 306 traffic associated with the passenger's desired sleep and travel plans and determine an initial route. The system may then determine 308 a schedule for the passenger, including, for example, the best time to awaken or transport the sleeping passenger for the travel. When it is time, the system wakes 310 her at home or transports her from the home, and either gets ready for work or defers getting ready until arrival (which may depend on the nature of the vehicle and ability to defer getting ready). It will be appreciated that in a simpler system the passenger is woken at home and then falls asleep again for travel. In another embodiment, as discussed above, the passenger is already in a travel pod or compartment that may be moved into the vehicle without disturbing the passenger.

The system them determines 312 a driving route and the passenger departs 314. While driving the vehicle monitors 316 the passenger. The system also monitors 318 the traffic environment. It can be expected that after starting the initial route, the system may detect an issue, which may be an issue detected while monitoring 316 the passenger, or it may be from an upcoming issue, such as traffic from congestion, construction, an accident, emergency needs, etc. The system determine if 320 the monitored 316, 318 statuses suggest adjusting the route. For example, if the issue is traffic congestion, to keep her vehicle from adding to the congestion, the system returns to determining 312 the navigation route and redirects the vehicle to parks in a secure area for some period of time to allow the situation to resolve/ease up. It will be appreciated the passenger's vehicle, along with other vehicles, may cooperatively interrupt their travel for different periods of time so that the issue can be resolved while still prioritizing vehicles according to their schedules or other system priorities. When it is time to continue, the vehicle may continue travel, e.g., continue brining the passenger to work.

After completing the rerouting, or if 320 it was not needed, travel will eventually be nearly completed 322. As the vehicle approaches work, it may employ careful ambient sound control and gentle parking maneuvers to allow her to stay asleep if it is not yet time to wake her. At a determined time, e.g., according to her preference, where she appears to be in her monitored sleep cycle, based on a hard stop, e.g., must awaken no later than five minutes before work or before arrival at the workplace, the system alerts 324 the passenger and induces waking. It will be appreciated if the passenger had awoken early she could have elected to arrive early, take a more scenic route, etc. Once awake, she may arrive 326 to work.

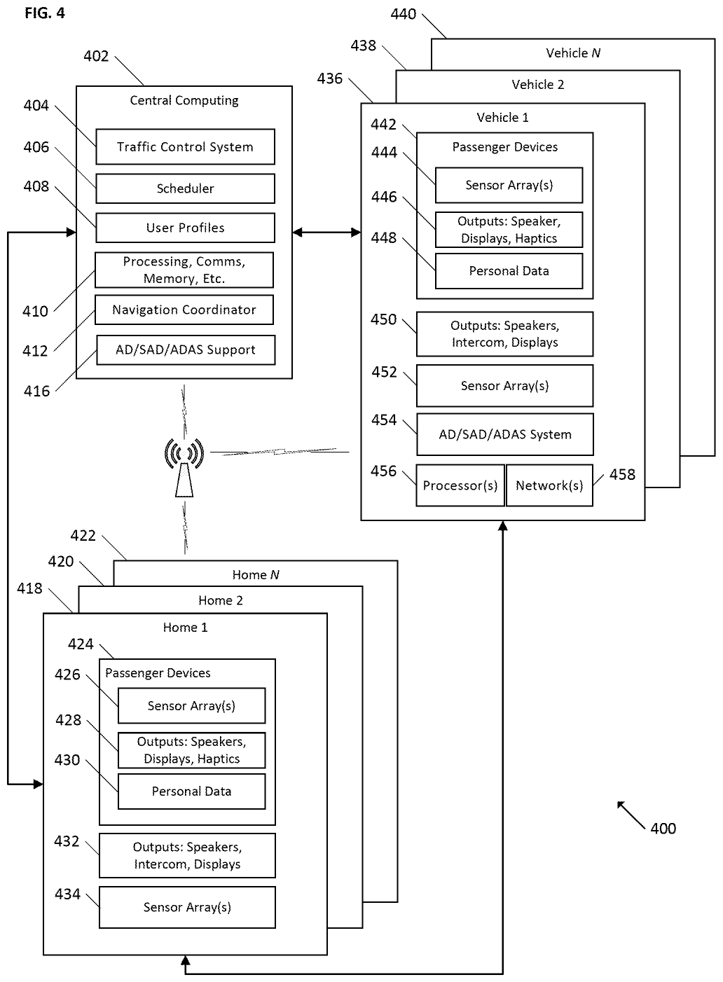

FIG. 4 illustrates an exemplary environment 400 illustrating a system including exemplary components for a central computing 402 resource that may be used to implement traffic control and provide other resources to support autonomous vehicles, e.g., the AD/SAD vehicles discussed above. The National Transportation Communications for Intelligent Transportation System Protocol (NTCIP) provides standards for interoperability of cars and infrastructure from multiple manufactures. One goals of the standard is to provide better efficiency, safety, and fuel efficiency by allowing monitoring across vehicles and infrastructure (e.g., car locations, accidents) in order to control infrastructure (e.g., metering lights, warnings) to optimize traffic efficiency. Traffic modelling may be used to anticipate how changes in infrastructure behavior can affect traffic patterns. The illustrated embodiment provides a central computing system that may influence the supply and routing of vehicles into a traffic system. Traffic modelling may be used to anticipate how many vehicles may be entering the traffic system, and central computing may coordinate with homes 418-422 and vehicles 436-440 to arrange for distributing passenger departures to improve traffic system efficiency.

Although a single central computing is illustrated it will be appreciated there may be multiple computing facilities working together to manage travel for different vehicles, e.g., cars, buses, trains, planes, motorcycles, bicycles, drones, etc., and the movement of these vehicles may be coordinated with the movement of non-vehicles such as people, animals, etc. The central computing, in one embodiment, includes a traffic control system 404 which may operate as discussed above to coordinate vehicle movement. There may also be a scheduler 406 which may receive various schedules from vehicles, as well as maintain schedules for regional activities, events, construction, weather related concerns, etc. and a storage for receiving and storing user profiles 408. This storage may be separate from or part of typical computing environment components 410 such as processors, communications equipment, memory, etc. In the illustrated embodiment there may also be a traffic coordinator 412 that may coordinate with the scheduler, to review the user profiles and determine or update navigation plans for the vehicles involved with the traffic control system. These plans and updates may be pushed to the vehicles and/or retrieved by the vehicles over a network. It will be appreciated that the central computing will provide AD/SAD/ADAS support 416 to provide information to vehicles to help them make decisions that help avoid accidents, warn them of potential problems, and provide for taking control of a vehicle in an emergency.

Also illustrated are exemplary home diagrams 418-422 representing any number of homes that may provide input to the central computing 402 environment. As illustrated it is expected that the person that will be traveling (passenger) may have associated devices, e.g., sensors 426, various outputs (visual, audio, haptic, etc.) 428, and personal data 430 including a schedule, profile, communications preferences, etc. The house itself will have a variety of automation and control features not illustrated, in addition to various outputs 432 such as speakers, intercom, displays, etc. that may be used to communicate with the passenger. There may also be sensor array(s) to facilitate monitoring the passenger for waking and performing other tasks requiring the passenger's state.

Also illustrates are exemplary vehicle diagrams 436-440 representing any number of vehicles that may be traveling within the scope of the traffic control system 404 managed by the central computing 402. As with the home, in the illustrated embodiment the passenger has associated passenger devices 442, e.g., sensors to monitor the passenger, outputs 446 to communicate with the passenger, and personal data 448 such as schedule, profile, and communication preferences. It will be appreciated that the home personal data 430 may contain the same information the vehicle personal data 448. The vehicle will have a variety of automation and control features not illustrated, in addition to various outputs 450 such as speakers, intercom, displays, etc. that may be used to communicate with the passenger. There may also be sensor array(s) 452 and processor(s) 454 to facilitate monitoring the vehicle's environment. It will be appreciated that the vehicle sensor array(s) 452 may include the same kinds of sensor array(s) 444 associated with the home, but the vehicle may include other sensors for use in the AD/SAD/ADAS system 454. For example the vehicle sensor array(s) may include technology for determining imaging around the vehicle, such as LIDAR, radar, etc. that may work with the processor(s) 456 to perform image analysis, implement computer vision, and process networking 458 communication, whether in-vehicle, vehicle to vehicle, or communication with the central computing 402.

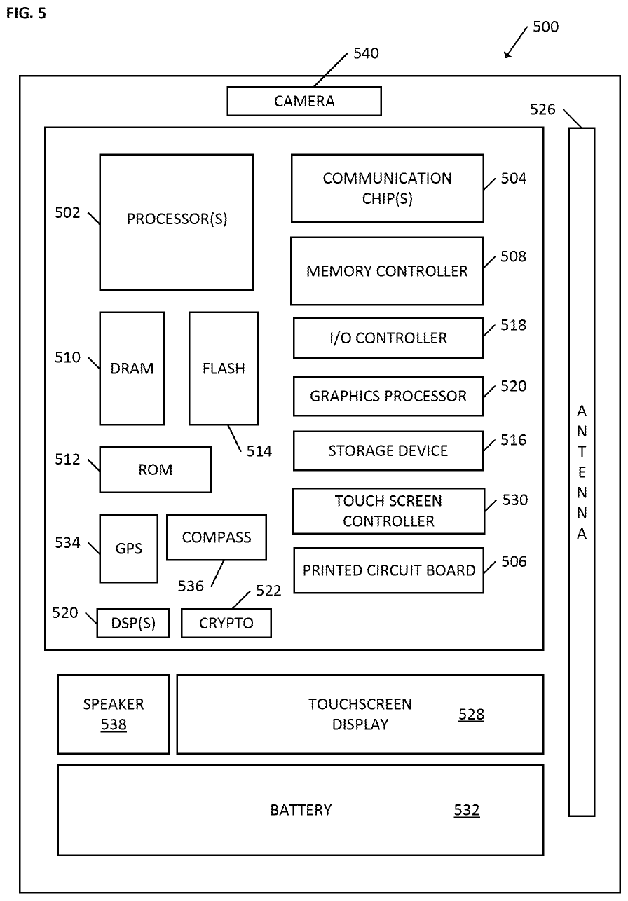

FIG. 5 illustrates an exemplary computer device 500 that may employ the apparatuses and/or methods described herein (e.g., to implement portions of FIG. 4 central computing 402, home(s) 418-422, or vehicle(s) 436-440), in accordance with various embodiments. As shown, computer device 500 may include a number of components, such as one or more processor(s) 502 (one shown) and at least one communication chip(s) 504. In various embodiments, the one or more processor(s) 502 each may include one or more processor cores. In various embodiments, the at least one communication chip 504 may be physically and electrically coupled to the one or more processor(s) 502. In further implementations, the communication chip(s) 504 may be part of the one or more processor(s) 502. In various embodiments, computer device 500 may include printed circuit board (PCB) 506. For these embodiments, the one or more processor(s) 502 and communication chip(s) 504 may be disposed thereon. In alternate embodiments, the various components may be coupled without the employment of PCB 506.

Depending on its applications, computer device 500 may include other components that may or may not be physically and electrically coupled to the PCB 506. These other components include, but are not limited to, memory controller 508, volatile memory (e.g., dynamic random access memory (DRAM) 510), non-volatile memory such as read only memory (ROM) 512, flash memory 514, storage device 516 (e.g., a hard-disk drive (HDD)), an I/O controller 518, a digital signal processor 520, a crypto processor 522, a graphics processor 524 (e.g., a graphics processing unit (GPU) or other circuitry for performing graphics), one or more antenna 526, a display which may be or work in conjunction with a touch screen display 528, a touch screen controller 530, a battery 532, an audio codec (not shown), a video codec (not shown), a positioning system such as a global positioning system (GPS) device 534 (it will be appreciated other location technology may be used), a compass 536, an accelerometer (not shown), a gyroscope (not shown), a speaker 538, a camera 540, and other mass storage devices (such as hard disk drive, a solid state drive, compact disk (CD), digital versatile disk (DVD)) (not shown), and so forth.

In some embodiments, the one or more processor(s) 502, flash memory 514, and/or storage device 516 may include associated firmware (not shown) storing programming instructions configured to enable computer device 500, in response to execution of the programming instructions by one or more processor(s) 502, to practice all or selected aspects of the methods described herein. In various embodiments, these aspects may additionally or alternatively be implemented using hardware separate from the one or more processor(s) 502, flash memory 514, or storage device 516. In one embodiment, memory, such as flash memory 514 or other memory in the computer device, is or may include a memory device that is a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In various embodiments, one or more components of the computer device 500 may implement an embodiment of the FIG. 1 vehicles 102-108, the FIG. 4 central computing 402, or homes 418-422. Thus for example processor 502 could be the FIG. 4 processing 410 or processor(s) 456 communicating with memory 510 though memory controller 508. In some embodiments, I/O controller 518 may interface with one or more external devices to receive a data. Additionally, or alternatively, the external devices may be used to receive a data signal transmitted between components of the computer device 500.

The communication chip(s) 504 may enable wired and/or wireless communications for the transfer of data to and from the computer device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip(s) may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMA5), Bluetooth, derivatives thereof, as well as any other wireless protocols that are designated as 3G, 4G, 5G, and beyond. The computer device may include a plurality of communication chips 504. For instance, a first communication chip(s) may be dedicated to shorter range wireless communications such as Wi-Fi and Bluetooth, and a second communication chip 504 may be dedicated to longer range wireless communications such as GPS, EDGE, GPRS, CDMA, WiMA5, LTE, Ev-DO, and others.

The communication chip(s) may implement any number of standards, protocols, and/or technologies datacenters typically use, such as networking technology providing high-speed low latency communication. For example, the communication chip(s) may support RoCE (Remote Direct Memory Access (RDMA) over Converged Ethernet), e.g., version 1 or 2, which is a routable protocol having efficient data transfers across a network, and is discussed for example at Internet URL RDMAconsortium.com. The chip(s) may support Fibre Channel over Ethernet (FCoE), iWARP, or other high-speed communication technology, see for example the OpenFabrics Enterprise Distribution (OFED™) documentation available at Internet URL OpenFabrics.org. It will be appreciated datacenter environments benefit from highly efficient networks, storage connectivity and scalability, e.g., Storage Area Networks (SANs), parallel computing using RDMA, Internet Wide Area Remote Protocol (iWARP), InfiniBand Architecture (IBA), and other such technology. Computer device 500 may support any of the infrastructures, protocols and technology identified here, and since new high-speed technology is always being implemented, it will be appreciated by one skilled in the art that the computer device is expected to support equivalents currently known or technology implemented in future.

In various implementations, the computer device 500 may be a laptop, a netbook, a notebook, an ultrabook, a smartphone, a computer tablet, a personal digital assistant (PDA), an ultra-mobile PC, a mobile phone, a desktop computer, a server, a printer, a scanner, a monitor, a set-top box, an entertainment control unit (e.g., a gaming console or automotive entertainment unit), a digital camera, an appliance, a portable music player, or a digital video recorder, or a transportation device (e.g., any motorized or manual device such as a bicycle, motorcycle, automobile, taxi, train, plane, etc.). In further implementations, the computer device 500 may be any other electronic device that processes data.

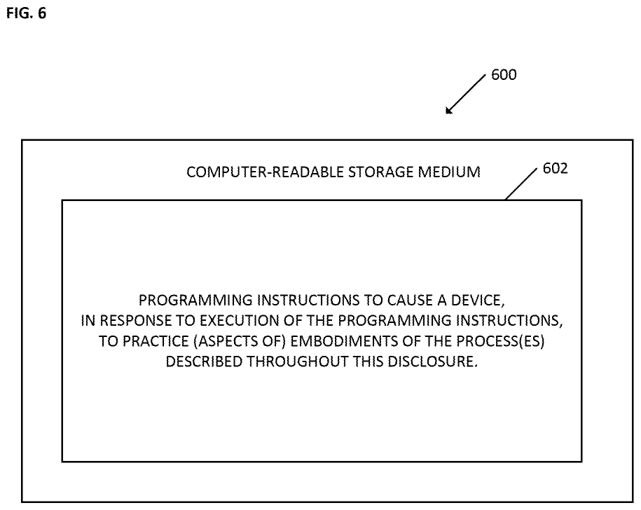

FIG. 6 illustrates an exemplary computer-readable storage medium 600. The storage medium may be transitory, non-transitory or a combination of transitory and non-transitory media, and the medium may be suitable for use to store instructions that cause an apparatus, machine or other device, in response to execution of the instructions by the apparatus, to practice selected aspects of the present disclosure. As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. As shown, non-transitory computer-readable storage medium 602 may include a number of programming instructions 604. Programming instructions 604 may be configured to enable a device, e.g., computer device 500, in response to execution of the programming instructions, to implement (aspects of) the sidecar technology disclosed herein. In alternate embodiments, programming instructions 604 may be disposed on multiple computer-readable non-transitory storage media 602 instead. In still other embodiments, programming instructions 604 may be disposed on computer-readable transitory storage media 602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Cooperative program execution may be for a fee based on a commercial transaction, such as a negotiated rate (offer/accept) arrangement, established and/or customary rates, and may include micropayments between device(s) cooperatively executing the program or storing and/or managing associated data.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Example 1 may be a traffic control system for directing traffic of a plurality of vehicles including a first vehicle having an associated first passenger and a second vehicle having an associated second passenger, the system comprising: a transceiver to communicatively couple with the plurality of vehicles; a scheduler to receive travel plans for selected ones of the plurality of vehicles, the travel plans determined based at least in part on travel constraints or preferences associated with the selected ones, the preferences providing for indicating sleep constraints; determine traffic control directives based at least in part on the received travel plans and at least one traffic constraint associated with a measurement of a traffic; and a director to direct the transceiver to send the traffic control directives to one or more of the plurality of vehicles.

Example 2 may be the traffic control system of example 1, wherein the scheduler receives first and second travel plans associated with the first and second vehicle.

Example 3 may be the traffic control system of example 2, wherein a first travel constraint for the first passenger includes a first destination location and a first arrive-by time for the first passenger, and a second travel constraint for the second passenger includes a second arrive-by time for the second passenger.

Example 4 may be the traffic control system of example 3, wherein the preference for the first passenger may include a sleeping preference for the first passenger, and the director to direct the first vehicle to drive faster than the second vehicle.

Example 5 may be the traffic control system of examples 1-4, further comprising an optimizer to evaluate the traffic, determine travel constraints based at least in part on the received travel plans, dynamically determine a traffic plan based at least in part satisfying the travel constraints with respect to the measurement, and implement the traffic plan by at least to instruct the director to send at least one directive with the transceiver to selected ones of the plurality of vehicles.

Example 6 may be a method for operating an autonomous vehicle associated with a passenger, comprising: receiving a schedule including an associated destination; receiving a profile including travel constraints or preferences for the passenger, the preferences including a selected one or more of sleep constraints and predicted sleeping stages; receiving a traffic status; generating a route for the autonomous vehicle based at least in part on the destination, the profile, and the traffic status; determining a time to transition the passenger to the autonomous vehicle; monitoring the passenger during autonomous operation of the autonomous vehicle; and dynamically adjusting the route based at least in part on the monitoring the passenger.

Example 7 may be example 6, wherein the predicted sleeping stage includes at least a predicted time of light sleeping, and the transition the passenger includes transitioning the passenger contemporaneous with the predicted time of light sleeping to facilitate a return to sleep during travel to the destination.

Example 8 may be example 7, wherein the transition the passenger to the autonomous vehicle includes waking the passenger.

Example 9 may be examples 6-8, wherein the transition the passenger includes autonomously moving a sleeping platform for the passenger from a first location into the autonomous vehicle.

Example 10 may be examples 6-9, wherein the travel constraints include a selected one or more of an arrival deadline, a preferred route, a type of preferred route.

Example 11 may be examples 6-10, wherein the preferences include a selected on or more of a number of desired hours of sleep, a desired wake-time, a music type, a lighting type, a background sound type, an alert type.

Example 12 may be examples 6-11, wherein monitoring the passenger includes predicting times of light sleeping and adjusting the route based on the predicting to minimize disturbances to the passenger.

Example 13 may be example 12, wherein the adjusting the route comprises a selected one or more of rerouting the vehicle: along a slower route, to a smoother road, along a route with fewer vehicles, to a quieter road, or stopping the vehicle.

Example 14 may be a method for a first entity of multiple entities to coordinate travel with at least a second entity, the entities including a traffic control, at least one home, and at least one vehicle, and the vehicle having an associated passenger, the method comprising: establishing communication between the first entity and at least two of the entities; exchanging, between at least two of the entities, at least one travel plan for the at least one vehicle, the travel plan determined based at least in part on a travel constraint or a preference associated with the at least one vehicles, the preference indicating a sleep constraint during the coordinated travel; exchanging, with the at least one vehicle, traffic control directives determined based at least in part on the travel plan and at least one traffic constraint associated with a measurement of a traffic.

Example 15 may be example 14, further comprising: receiving at least one travel plan associated with the at least one vehicle.

Example 16 may be example 15, wherein a first travel constraint for the passenger includes a destination location and an arrive-by time for the first passenger.

Example 17 may be example 16, in which the preference includes a sleeping preference for the passenger, and wherein a travel priority for the vehicle is based at least in part on the sleeping preference.

Example 18 may be one or more non-transitory computer-readable media having instructions to provide for operating an autonomous vehicle associated with a passenger, the instructions, when executed, provide for: receiving a schedule including an associated destination; receiving a profile including travel constraints or preferences for the passenger, the preferences including a selected one or more of sleep constraints and predicted sleeping stages; receiving a traffic status; generating a route for the autonomous vehicle based at least in part on the destination, the profile, and the traffic status; determining a time to transition the passenger to the autonomous vehicle; monitoring the passenger during autonomous operation of the autonomous vehicle; and dynamically adjusting the route based at least in part on the monitoring the passenger.

Example 19 may be example 18 further having instructions to provide for: inspecting the predicted sleeping stage to at least identify a predicted time of light sleeping; and transitioning the passenger contemporaneous with the predicted time of light sleeping to facilitate a return to sleep during travel to the destination.

Example 20 may be example 19, wherein the instructions to transition the passenger to the autonomous vehicle includes instructions to enable waking the passenger.

Example 21 may be examples 18-19, further having instructions to provide for autonomously moving a sleeping platform for the passenger from a first location into the autonomous vehicle.

Example 22 may be examples 18-21, further having instructions to provide for: identifying travel constraints including a selected one or more of an arrival deadline, a preferred route, a type of preferred route; and adjusting the operating the autonomous vehicle based at least in part on the identified travel constraints.

Example 23 may be example 22, further having instructions to provide for: identifying preferences including a selected on or more of a number of desired hours of sleep, a desired wake-time, a music type, a lighting type, a background sound type, an alert type; and adjusting the operating the autonomous vehicle based at least in part on the identified preferences.

Example 24 may be examples 18-23, the instructions for monitoring the passenger further having instructions to provide for: predicting times of light sleeping and adjusting the route based on the predicting to minimize disturbances to the passenger.

Example 25 may be example 24, the instructions for adjusting the route further having instructions to provide for a selected one or more of rerouting the vehicle: along a slower route, to a smoother road, along a route with fewer vehicles, to a quieter road, or stopping the vehicle.

Example 26 may be a means for directing traffic of a plurality of vehicles including a first vehicle having an associated first passenger and a second vehicle having an associated second passenger, the means comprising: means for a transceiver to communicatively couple with the plurality of vehicles; means for a scheduler to receive travel plans for selected ones of the plurality of vehicles, the travel plans determined based at least in part on travel constraints or preferences associated with the selected ones, the preferences providing for indicating sleep constraints; means to determine traffic control directives based at least in part on the received travel plans and at least one traffic constraint associated with a measurement of a traffic; and means for a director to direct the transceiver to send the traffic control directives to one or more of the plurality of vehicles.

Example 27 may be example 26, further comprising means for an optimizer to evaluate the traffic, determine travel constraints based at least in part on the received travel plans, dynamically determine a traffic plan based at least in part satisfying the travel constraints with respect to the measurement, and implement the traffic plan by at least to instruct the director to send at least one directive with the transceiver to selected ones of the plurality of vehicles.

Example 28 may be means for operating an autonomous vehicle associated with a passenger, comprising: means for receiving a schedule including an associated destination; means for receiving a profile including travel constraints or preferences for the passenger, the preferences including a selected one or more of sleep constraints and predicted sleeping stages; means for receiving a traffic status; means for generating a route for the autonomous vehicle based at least in part on the destination, the profile, and the traffic status; means for determining a time to transition the passenger to the autonomous vehicle; means for monitoring the passenger during autonomous operation of the autonomous vehicle; and means for dynamically adjusting the route based at least in part on the monitoring the passenger.

Example 29 may be example 28, wherein the means for monitoring the passenger includes means for predicting times of light sleeping and adjusting the route based on the predicting to minimize disturbances to the passenger.

Example 30 may be example 28, wherein the means for adjusting the route comprises a selected one or more of rerouting the vehicle: along a slower route, to a smoother road, along a route with fewer vehicles, to a quieter road, or stopping the vehicle.

Example 31 may be means for a first entity of multiple entities to coordinate travel with at least a second entity, the entities including a traffic control, at least one home, and at least one vehicle, and the vehicle having an associated passenger, the means comprising: means for establishing communication between the first entity and at least two of the entities; means for exchanging, between at least two of the entities, at least one travel plan for the at least one vehicle, the travel plan determined based at least in part on a travel constraint or a preference associated with the at least one vehicles, the preference indicating a sleep constraint during the coordinated travel; and means for exchanging, with the at least one vehicle, traffic control directives determined based at least in part on the travel plan and at least one traffic constraint associated with a measurement of a traffic.

Example 32 may be example 31, further comprising: means for receiving at least one travel plan associated with the at least one vehicle.

Example 33 may be any of examples 1-4, further comprising an optimizer to evaluate the traffic, determine travel constraints based at least in part on the received travel plans, dynamically determine a traffic plan based at least in part satisfying the travel constraints with respect to the measurement, and implement the traffic plan by at least to instruct the director to send at least one directive with the transceiver to selected ones of the plurality of vehicles.

Example 34 may be any of examples 6-8 wherein the transition the passenger includes autonomously moving a sleeping platform for the passenger from a first location into the autonomous vehicle.

Example 35 may be any of examples 6-9 wherein the travel constraints include a selected one or more of an arrival deadline, a preferred route, a type of preferred route.

Example 36 may be any of examples 6-10 wherein the preferences include a selected on or more of a number of desired hours of sleep, a desired wake-time, a music type, a lighting type, a background sound type, an alert type.

Example 37 may be any of examples 6-11 wherein monitoring the passenger includes predicting times of light sleeping and adjusting the route based on the predicting to minimize disturbances to the passenger.

Example 38 may be any of examples 18-20, further having instructions to provide for autonomously moving a sleeping platform for the passenger from a first location into the autonomous vehicle.

Example 39 may be any of examples 18-21, further having instructions to provide for: identifying travel constraints including a selected one or more of an arrival deadline, a preferred route, a type of preferred route; and adjusting the operating the autonomous vehicle based at least in part on the identified travel constraints.

Example 40 may be any of examples 18-23, the instructions for monitoring the passenger further having instructions to provide for: predicting times of light sleeping and adjusting the route based on the predicting to minimize disturbances to the passenger.

Example 41 may be any of examples 18-23, the instructions for monitoring the passenger further having instructions to provide for: predicting times of light sleeping and adjusting the route based on the predicting to minimize disturbances to the passenger; wherein the instructions for adjusting the route further having instructions to provide for a selected one or more of rerouting the vehicle: along a slower route, to a smoother road, along a route with fewer vehicles, to a quieter road, or stopping the vehicle.

Example 42 may be any of examples 28-29, wherein the means for adjusting the route comprises a selected one or more of rerouting the vehicle: along a slower route, to a smoother road, along a route with fewer vehicles, to a quieter road, or stopping the vehicle.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1.-25. (canceled)

26. A traffic control system for directing traffic of a plurality of vehicles including a first vehicle having an associated first passenger and a second vehicle having an associated second passenger, the system comprising:
a transceiver to communicatively couple with the plurality of vehicles;
a scheduler to receive travel plans for selected ones of the plurality of vehicles, the travel plans determined based at least in part on travel constraints or preferences associated with the selected ones, the preferences providing for indicating sleep constraints;
determine traffic control directives based at least in part on the received travel plans and at least one traffic constraint associated with a measurement of a traffic; and
a director to direct the transceiver to send the traffic control directives to one or more of the plurality of vehicles.

27. The traffic control system of claim 26, wherein the scheduler receives first and second travel plans associated with the first and second vehicle.

28. The traffic control system of claim 27, wherein a first travel constraint for the first passenger includes a first destination location and a first arrive-by time for the first passenger, and a second travel constraint for the second passenger includes a second arrive-by time for the second passenger.

29. The traffic control system of claim 28, wherein the preference for the first passenger may include a sleeping preference for the first passenger, and the director to direct the first vehicle to drive faster than the second vehicle.

30. The traffic control system of claim 26, further comprising an optimizer to evaluate the traffic, determine travel constraints based at least in part on the received travel plans, dynamically determine a traffic plan based at least in part satisfying the travel constraints with respect to the measurement, and implement the traffic plan by at least to instruct the director to send at least one directive with the transceiver to selected ones of the plurality of vehicles.

31. A method for operating an autonomous vehicle associated with a passenger, comprising:
receiving a schedule including an associated destination;
receiving a profile including travel constraints or preferences for the passenger, the preferences including a selected one or more of sleep constraints and predicted sleeping stages;
receiving a traffic status;
generating a route for the autonomous vehicle based at least in part on the destination, the profile, and the traffic status;
determining a time to transition the passenger to the autonomous vehicle;
monitoring the passenger during autonomous operation of the autonomous vehicle;
and dynamically adjusting the route based at least in part on the monitoring the passenger.

32. The method of claim 31, wherein the predicted sleeping stage includes at least a predicted time of light sleeping, and the transition the passenger includes transitioning the passenger contemporaneous with the predicted time of light sleeping to facilitate a return to sleep during travel to the destination.

33. The method of claim 32, wherein the transition the passenger to the autonomous vehicle includes waking the passenger.

34. The method of claim 31 wherein the transition the passenger includes autonomously moving a sleeping platform for the passenger from a first location into the autonomous vehicle.

35. The method of claim 31 wherein the travel constraints include a selected one or more of an arrival deadline, a preferred route, a type of preferred route.

36. The method of claim 31 wherein the preferences include a selected on or more of a number of desired hours of sleep, a desired wake-time, a music type, a lighting type, a background sound type, an alert type.

37. The method of claim 31 wherein monitoring the passenger includes predicting times of light sleeping and adjusting the route based on the predicting to minimize disturbances to the passenger.

38. The method of claim 37, wherein the adjusting the route comprises a selected one or more of rerouting the vehicle: along a slower route, to a smoother road, along a route with fewer vehicles, to a quieter road, or stopping the vehicle.

39. A method for a first entity of multiple entities to coordinate travel with at least a second entity, the entities including a traffic control, at least one home, and at least one vehicle, and the vehicle having an associated passenger, the method comprising:
establishing communication between the first entity and at least two of the entities;
exchanging, between at least two of the entities, at least one travel plan for the at least one vehicle, the travel plan determined based at least in part on a travel constraint or a preference associated with the at least one vehicles, the preference indicating a sleep constraint during the coordinated travel;
exchanging, with the at least one vehicle, traffic control directives determined based at least in part on the travel plan and at least one traffic constraint associated with a measurement of a traffic.

40. The method to coordinate travel of claim 39, further comprising:
receiving at least one travel plan associated with the at least one vehicle.

41. The method to coordinate travel of claim 40, wherein a first travel constraint for the passenger includes a destination location and an arrive-by time for the passenger.

42. The method to coordinate travel of claim 41, in which the preference includes a sleeping preference for the passenger, and wherein a travel priority for the vehicle is based at least in part on the sleeping preference.

43. One or more non-transitory computer-readable media having instructions for operating an autonomous vehicle associated with a passenger, the instructions, when executed, provide for:
receiving a schedule including an associated destination;
receiving a profile including travel constraints or preferences for the passenger, the preferences including a selected one or more of sleep constraints and predicted sleeping stages;
receiving a traffic status;
generating a route for the autonomous vehicle based at least in part on the destination, the profile, and the traffic status;
determining a time to transition the passenger to the autonomous vehicle;
monitoring the passenger during autonomous operation of the autonomous vehicle;
and dynamically adjusting the route based at least in part on the monitoring the passenger.

44. The computer-readable media of claim 43 further having instructions to provide for:
inspecting the predicted sleeping stage to at least identify a predicted time of light sleeping; and
transitioning the passenger contemporaneous with the predicted time of light sleeping to facilitate a return to sleep during travel to the destination.

45. The computer-readable media of claim 44, wherein the instructions to transition the passenger to the autonomous vehicle includes instructions to enable waking the passenger.

46. The computer-readable media of claim 43, further having instructions to provide for autonomously moving a sleeping platform for the passenger from a first location into the autonomous vehicle.

47. The computer-readable media of claim 43, further having instructions to provide for:
identifying travel constraints including a selected one or more of an arrival deadline, a preferred route, a type of preferred route; and
adjusting the operating the autonomous vehicle based at least in part on the identified travel constraints.

48. The computer-readable media of claim 47, further having instructions to provide for:
identifying preferences including a selected on or more of a number of desired hours of sleep, a desired wake-time, a music type, a lighting type, a background sound type, an alert type; and
adjusting the operating the autonomous vehicle based at least in part on the identified preferences.

49. The computer-readable media of claim 43, the instructions for monitoring the passenger further having instructions to provide for:
predicting times of light sleeping and adjusting the route based on the predicting to minimize disturbances to the passenger.

50. The computer-readable media of claim 49, the instructions for adjusting the route further having instructions to provide for a selected one or more of rerouting the vehicle: along a slower route, to a smoother road, along a route with fewer vehicles, to a quieter road, or stopping the vehicle.
